(19) United States
(12) Patent Application Publication
(10) Pub. No.: US 2018/0159607 A1
(43) Pub. Date: Jun. 7, 2018

(54) RF BEAMFORMING CONTROL IN A COMMUNICATION SYSTEM

(71) Applicant: NOKIA SOLUTIONS AND NETWORKS OY, Espoo (FI)

(72) Inventors: Marcin RYBAKOWSKI, Rawicz (PL); Jacek GORA, Wroclaw (PL); Krystian SAFJAN, Nowy Sacz (PL)

(21) Appl. No.: 15/570,432

(22) PCT Filed: Apr. 30, 2015
(86) PCT No.: PCT/EP2015/059565

§ 371 Date: Oct. 30, 2017

(51) Int. Cl. H04B 7/06; H04W 24/08; H04B 17/318; H04B 17/336

(52) U.S. Cl. CPC H04B 7/0617; H04B 17/336; H04B 17/318; H04W 24/08

(57) ABSTRACT

A method for wireless communications, comprising: determining at least one performance characteristic associated with a received narrow width beam millimetre wavelength signal; determining at least one performance characteristic associated with a received wide width beam centimetre wavelength signal; determining a signal related event based on the at least one performance characteristic associated with a received narrow width beam millimetre wavelength signal and the at least one performance characteristic associated with a received wide width beam centimetre wavelength signal; and controlling an antenna beam for transmitting and receiving the millimetre wavelength signal based on the signal related event.

This disclosure relates to wireless communication and more particularly to wireless communication via antenna beams provided by access points and user equipment of a communication system.

A communication system can be seen as a facility that enables communication between two or more nodes such as fixed or mobile communication devices, access points such as base stations, servers, machine-type devices and so on. A communication system and compatible communicating entities typically operate in accordance with a given standard or specification which sets out what the various entities associated with the system are permitted to do and how that should be achieved. For example, the standards, specifications and related protocols can define the manner how communications between communication devices and the access points shall be arranged, how various aspects of the communications shall be provided and how the equipment shall be configured.

Signals can be carried on wireless carriers. Examples of wireless systems include public land mobile networks (PLMN) such as cellular networks, satellite based communication systems and different wireless local networks, for example wireless local area networks (WLAN). Wireless systems can be divided into coverage areas referred to as cells, and hence the wireless systems are often referred to as cellular systems. A base station can provide one or more cells, there being various different types of base stations and cells. In modern radio communication networks, such as the Long Term Evolution (LTE) or the LTE-Advanced (LTE-A) of the 3rd Generation Partnership Project (3GPP), common base stations (often called as Node B; NB or enhanced Node B; eNB) are used.

A user can access the communication system and communicate with other users by means of an appropriate communication device or terminal. Communication apparatus of a user is often referred to as a user equipment (UE). Typically a communication device is used for enabling receiving and transmission of communications such as speech and data. A communication device is provided with an appropriate signal receiving and transmitting arrangement for enabling communications.

To satisfy the increasing capacity demand use of millimeter wave (mmWave) spectrum for wireless communications has been proposed. For example, the future 5th generation (5G) wireless systems are envisioned to operate also in the millimeter wave spectrum. Millimeter wave systems are planned to be operated in >30 GHz frequency bands. High signal frequency can result in high propagation loss. To compensate for large propagation loss systems operated on millimeter wave spectrum use high gain antennas.

A possibility to provide high gain antennas is formulation of narrow beam antenna characteristics. Access points (APs) can use active antenna arrays for communication with communication devices such as the user equipment (UE). The active antenna arrays can dynamically form and steer narrow transmission/reception beams and serve multiple UEs and track their positions based on UE-specific beamforming. The active antenna arrays may be used both at the access point and at the user equipment to further enhance the beamforming potential.

The mmWave systems are anticipated to use large transmission bandwidth, e.g. bandwidths in the order of 1 GHz-2 GHz. Because of this analogue to digital converters (ADC) and digital to analogue converters (DAC) used for the transmissions need to operate with high sampling frequency. High sampling frequency of converters operating in mmWave bands can result high power consumption. High power consumption and expensive technologies may limit the usage of digital beamforming techniques where one ADC/DAC converter is connected to every antenna element in an antenna array. Because of this currently preferred radio frequency (RF) beamforming techniques use only one ADC for reception (RX) path and one DAC for transmission (TX) path per polarization for all antenna elements in an antenna array.

The RF beamforming however can require special techniques for alignment of antenna beams between an AP and a UE. RF beamforming typically comprises searching through all possible beam directions to identify the optimum beam which can be more time consuming than angle of arrival estimation techniques that are possible with digital beamforming.

For example when the mmWave AP and UE beams are aligned the following situation will trigger the RF beamforming procedure to find new alignments of beams:

1) Device rotation: in this case the beams directions are the same but device rotation causes that the UE beam is not aligned to the AP. The signal level will decrease and AP and UE must start RF beamforming (beam-alignment) procedures.

2) Device movement: in this case the beam alignments between the AP and UE are lost which is detected by decreasing of signal level. The RF beamforming (beam-alignment) procedures in both nodes must be started.

3) Beams blockage: the antenna beams aligned between the AP and UE are blocked by some moving obstacle (car, human etc.). The signal quality is dropped suddenly and significantly because mmWave communication relies mainly on line of sight communication. This trigger the RF beamforming (beam-alignment) procedures to find new beams alignment, for example to find the beams direction will allow communication by reflection without line of sight transmission

In such cases as discussed above the signal strength and/or quality drops in both nodes (AP and UE). This signal drops triggers RF beamforming (beam-alignment) procedure in one or two nodes. The RF beamforming (beam-alignment) procedure is the algorithm which scans the RF beams in AP and UE to find new beams alignment. The main problem in the RF beamforming (beam-alignment) algorithm design is the search time. The long delay time of searching the correct beams alignment may cause the following problems in system and device functionalities:
Significant hardware (HW) and software (SW) resource consumption due to algorithm operation
Loss of data throughput due to required processing time for RF beamforming (beam-alignment)
Loss of signal connection when RF beamforming (beam-alignment) procedure cannot find the correct beams in required time
Long delay time of access time to network after the UE switch on or when the UE reaches mmWave AP coverage
Long time of handover to new AP

Therefore the optimization of RF beamforming (beam-alignment) time operation is an aspect for reliable functionality of a mmWave system.

It is noted that the above discussed issues are not limited to any particular communication environment and station apparatus but may occur in any appropriate system where communications may be provided via antenna beams.

Embodiments of the invention aim to address one or several of the above issues.

According to a first aspect there is provided a method for wireless communications, comprising: determining at least one performance characteristic associated with a received first beamwidth signal; determining at least one performance characteristic associated with a received second beamwidth signal; determining a signal related event based on the at least one performance characteristic associated with the received first beamwidth signal and the at least one performance characteristic associated with the received second beamwidth signal; and controlling an antenna beam for transmitting and receiving the second beamwidth signal based on the signal related event.

Determining at least one performance characteristic associated with the received first beamwidth signal may comprise determining at least one of: a received signal strength level; a received signal to noise level; a round trip time; and an angle of arrival.

Determining at least one performance characteristic associated with the received second beamwidth signal may comprise determining at least one of: a received signal strength level; a received signal to noise level; a round trip time; and an angle of arrival.

Determining a signal related event based on the at least one performance characteristic associated with the received first beamwidth signal and the at least one performance characteristic associated with the received second beamwidth signal may comprise determining a device rotation event when the at least one performance characteristic associated with the received first beamwidth signal shows a change in signal greater than a first beamwidth signal rotation event threshold and the at least one performance characteristic associated with the received second beamwidth signal changes by less than a second beamwidth signal rotation event threshold.

Controlling an antenna beam for transmitting and receiving the second beamwidth signal based on the signal related event may comprise: controlling a device to search for a different antenna beam, wherein the search starts with antenna beams neighbouring a currently used antenna beam direction; and controlling a further device, connected to the device, to maintain using a currently used antenna beam.

The device may be a rotating device.

Controlling an antenna beam for transmitting and receiving the second beamwidth signal based on the signal related event as shown herein may be when the event is a device rotation event.

Determining a signal related event based on the at least one performance characteristic associated with the received first beamwidth signal and the at least one performance characteristic associated with the received second beamwidth signal may comprise determining a device motion event when the at least one performance characteristic associated with the received first beamwidth signal shows a change in signal greater than a first beamwidth signal motion event threshold and the at least one performance characteristic associated with the received second beamwidth signal shows a change in signal less than a second beamwidth signal motion event threshold.

Controlling an antenna beam for transmitting and receiving the second beamwidth signal based on the signal related event may comprise: controlling a device to search for a different antenna beam, wherein the search starts with antenna beams neighbouring a currently used antenna beam direction; and controlling a further device, connected to the device, to search for a different antenna beam, wherein the search starts with antenna beams neighbouring a currently used antenna beam direction.

The device may be a moving device.

Controlling an antenna beam for transmitting and receiving the second beamwidth signal based on the signal related event as shown herein may be when the event is a device motion event.

Determining a signal related event based on the at least one performance characteristic associated with the received first beamwidth signal and the at least one performance characteristic associated with the received second beamwidth signal may comprise determining a signal blockage event when the at least one performance characteristic associated with the received first beamwidth signal shows a change in signal greater than a first beamwidth signal blockage event threshold and the at least one performance characteristic associated with the received second beamwidth signal shows a change in signal greater than a second beamwidth signal blockage event threshold.

Controlling an antenna beam for transmitting and receiving the second beamwidth signal based on the signal related event may comprise: controlling a device to search for a different antenna beam; and controlling a further device, connected to the device, to search for a different antenna beam.

The device may be a blocked device.

Controlling an antenna beam for transmitting and receiving the second beamwidth signal based on the signal related event as shown herein may be when the event is a signal blockage event comprises.

According to a second aspect there is provided an apparatus for wireless communications, the apparatus comprising at least one processor, and at least one memory including computer program code, wherein the at least one memory and the computer program code are configured, with the at least one processor, to cause: determining at least one performance characteristic associated with the received first beamwidth signal; determining at least one performance characteristic associated with the received second beamwidth signal; determining a signal related event based on the at least one performance characteristic associated with the received first beamwidth signal and the at least one performance characteristic associated with the received second beamwidth signal; and controlling an antenna beam for transmitting and receiving the second beamwidth signal based on the signal related event.

Determining at least one performance characteristic associated with the received first beamwidth signal may cause the apparatus to determine at least one of: a received signal strength level; a received signal to noise level; a round trip time; and an angle of arrival.

Determining at least one performance characteristic associated with the received second beamwidth signal comprises may cause the apparatus to determine at least one of: a received signal strength level; a received signal to noise level; a round trip time; and an angle of arrival.

Determining a signal related event based on the at least one performance characteristic associated with the received first beamwidth signal and the at least one performance characteristic associated with the received second beamwidth signal may cause the apparatus to perform determining a device rotation event when the at least one performance characteristic associated with the received first beamwidth signal shows a change in signal greater than a first beamwidth signal rotation event threshold and the at least one performance characteristic associated with the received second beamwidth signal changes by less than a second beamwidth rotation event threshold.

Controlling an antenna beam for transmitting and receiving the second beamwidth signal based on the signal related event may cause the apparatus to: control a device to search for a different antenna beam, wherein the search starts with antenna beams neighbouring a currently used antenna beam direction; and control a further device connected to the rotating device to maintain using a currently used antenna beam.

The device may be a rotating device.

The controlling an antenna beam for transmitting and receiving the second beamwidth signal based on the signal related event as shown herein may be caused when the event is a device rotation event.

Determining a signal related event based on the at least one performance characteristic associated with the received first beamwidth signal and the at least one performance characteristic associated with the received second beamwidth signal causes the apparatus to perform determining a device motion event when the at least one performance characteristic associated with the received first beamwidth signal shows a change in signal greater than a first beamwidth signal motion event threshold and the at least one performance characteristic associated with the received second beamwidth signal shows a change in signal less than a second beamwidth signal motion event threshold.

Controlling an antenna beam for transmitting and receiving the second beamwidth signal based on the signal related event may cause the apparatus to perform: controlling a device to search for a different antenna beam, wherein the search starts with antenna beams neighbouring a currently used antenna beam direction; and controlling a further device, connected to the device, to search for a different antenna beam, wherein the search starts with antenna beams neighbouring a currently used antenna beam direction.

The device may be a moving device.

The controlling an antenna beam for transmitting and receiving the second beamwidth signal based on the signal related event as shown herein may be caused when the event is a device motion event.

Determining a signal related event based on the at least one performance characteristic associated with the received first beamwidth signal and the at least one performance characteristic associated with the received second beamwidth signal may cause the apparatus to perform determining a signal blockage event when the at least one performance characteristic associated with the received first beamwidth signal change in signal greater than a first beamwidth signal blockage event threshold and the at least one performance characteristic associated with the received second beamwidth signal shows change in signal greater than a second beamwidth signal blockage event threshold.

Controlling an antenna beam for transmitting and receiving the second beamwidth signal based on the signal related event may cause the apparatus to: control a device to search for a different antenna beam; and control a further device, connected to the device, to search for a different antenna beam.

The device may be a blocked device.

The controlling an antenna beam for transmitting and receiving the second beamwidth signal based on the signal related event as shown herein may be caused when the event is a signal blockage event.

According to a third aspect there is provided an a first beamwidth signal characteristic determiner configured to determine at least one performance characteristic associated with a received first beamwidth signal; a second beamwidth signal characteristic determiner configured to determine at least one performance characteristic associated with a received second beamwidth signal; an event determiner configured to determine a signal related event based on the at least one performance characteristic associated with the received first beamwidth signal and the at least one performance characteristic associated with the received second beamwidth signal; and a beamwidth controller configured to control an antenna beam for transmitting and receiving the second beamwidth signal based on the signal related event.

The first beamwidth signal characteristic determiner may be configured to determine at least one of: a received signal strength level; a received signal to noise level; a round trip time; and an angle of arrival.

The second beamwidth signal characteristic determiner may be configured to determine at least one of: a received signal strength level; a received signal to noise level; a round trip time; and an angle of arrival.

The event determiner may be configured to determine a device rotation event when the at least one performance characteristic associated with the received first beamwidth signal shows a change in signal greater than a first beamwidth signal rotation event threshold and the at least one performance characteristic associated with the received second beamwidth signal changes by less than a second beamwidth signal rotation event threshold.

The beamwidth controller may be configured to: control a device to search for a different antenna beam, wherein the search starts with antenna beams neighbouring a currently used antenna beam direction; and control a further device, connected to the device, to maintain using a currently used antenna beam.

The device may be a rotating device.

The beamwidth controller may be configured to control an antenna beam for transmitting and receiving the second beamwidth signal based on the signal related event as shown herein when the event is a device rotation event.

The event determiner may be configured to determine a device motion event when the at least one performance characteristic associated with the received first beamwidth signal shows a change in signal greater than a first beamwidth signal motion event threshold and the at least one performance characteristic associated with the received second beamwidth signal shows a change in signal less than a second beamwidth signal motion event threshold.

The beamwidth controller may be configured to: control a device to search for a different antenna beam, wherein the search starts with antenna beams neighbouring a currently used antenna beam direction; and control a further device, connected to the device, to search for a different antenna beam, wherein the search starts with antenna beams neighbouring a currently used antenna beam direction.

The device may be a moving device.

The beamwidth controller may be configured to control an antenna beam for transmitting and receiving the second beamwidth signal based on the signal related event as shown herein when the event is a device motion event.

The event determiner may be configured to determine a signal blockage event when the at least one performance characteristic associated with the received first beamwidth signal shows a change in signal greater than a first beamwidth signal blockage event threshold and the at least one performance characteristic associated with the received second beamwidth signal shows a change in signal greater than a second beamwidth signal blockage event threshold.

The beamwidth controller may be configured to: control a device to search for a different antenna beam; and control a further device, connected to the device, antenna beam to search for a different antenna beam.

The device may be a blocked device.

The beamwidth controller may be configured to control an antenna beam for transmitting and receiving the second beamwidth signal based on the signal related event as shown herein when the event is a signal blockage event comprises.

The first beamwidth signal characteristic determiner may be a millimetre wavelength signal characteristic determiner.

The second beamwidth signal characteristic determiner may be a centimetre wavelength signal characteristic determiner.

The first beamwidth signal may be a narrower beamwidth signal than the second beamwidth signal.

The first beamwidth signal may be a narrow beamwidth signal.

The second beamwidth signal may be an omnidirectional beamwidth signal.

The first beamwidth signal may be a narrow beamwidth millimetre wavelength signal.

The second beamwidth signal may be a wide beamwidth centimetre wavelength signal.

A device for a communication system may comprise the apparatus according to the above elements.

A computer program comprising code means adapted to perform the method discussed above when the program is run on processor apparatus.

A computer program comprising program code means adapted to perform the herein described methods may also be provided. In accordance with further embodiments apparatus and/or computer program product that can be embodied on a computer readable medium for providing at least one of the above methods is provided.

A network node such as a base station, a controller for an access system or a controller for core network may be configured to operate in accordance with at least some of the embodiments. A communications device adapted for the operation can also be provided. A communication system embodying the apparatus and principles of the invention may also be provided.

It should be appreciated that any feature of any aspect may be combined with any other feature of any other aspect.

Embodiments will now be described in further detail, by way of example only, with reference to the following examples and accompanying drawings, in which:

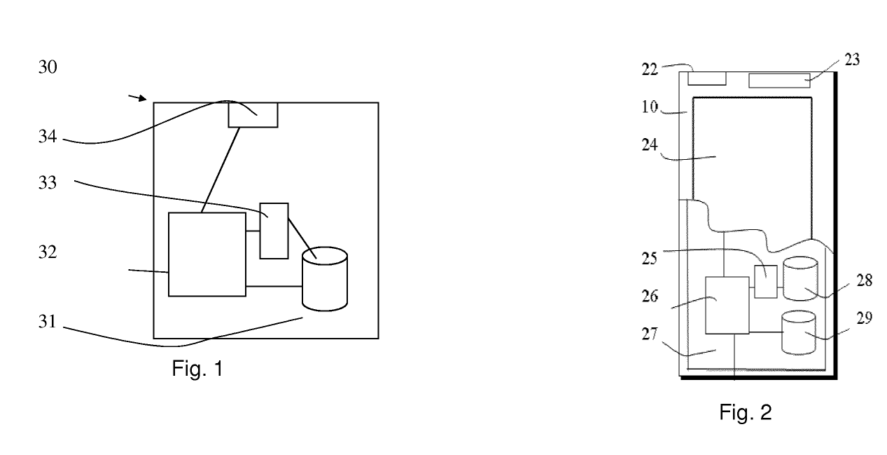

FIG. 1 shows a schematic diagram of a control apparatus according to some embodiments;

FIG. 2 shows a schematic presentation of a possible communication device;

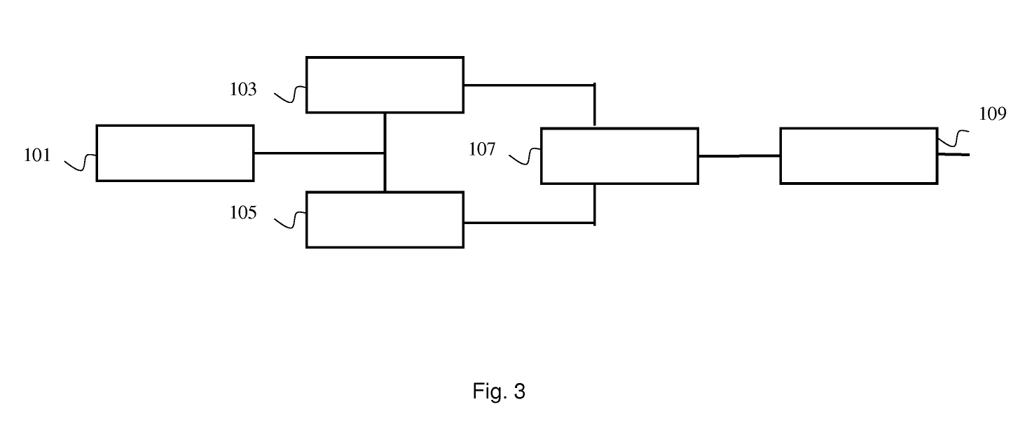

FIG. 3 shows a schematic diagram of a beamforming control apparatus according to some embodiments;

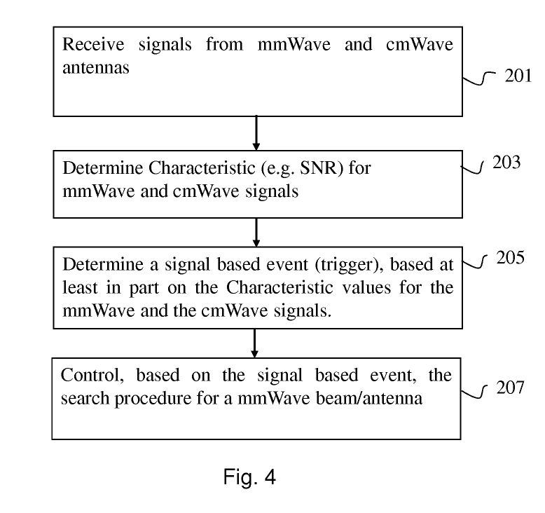

FIG. 4 shows a flowchart of the operation of the beamforming control apparatus as shown in FIG. 3 according to an example;

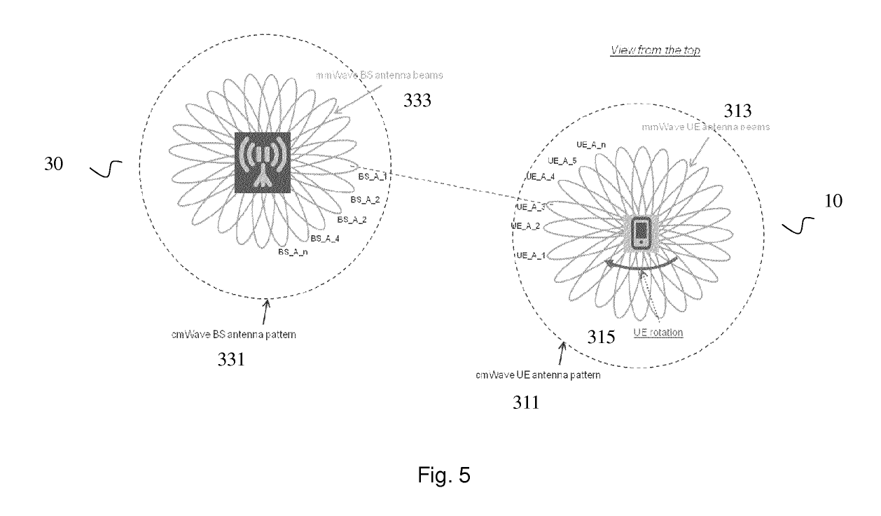

FIG. 5 shows an example beamforming control for a rotation of the user equipment relative to the access point;

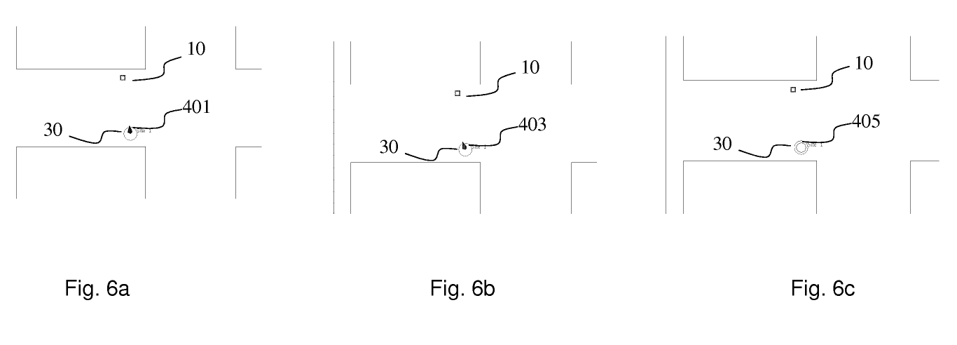

FIGS. 6a, 6b and 6c show example simulated beamforming control for a rotation of the user equipment relative to the access point;

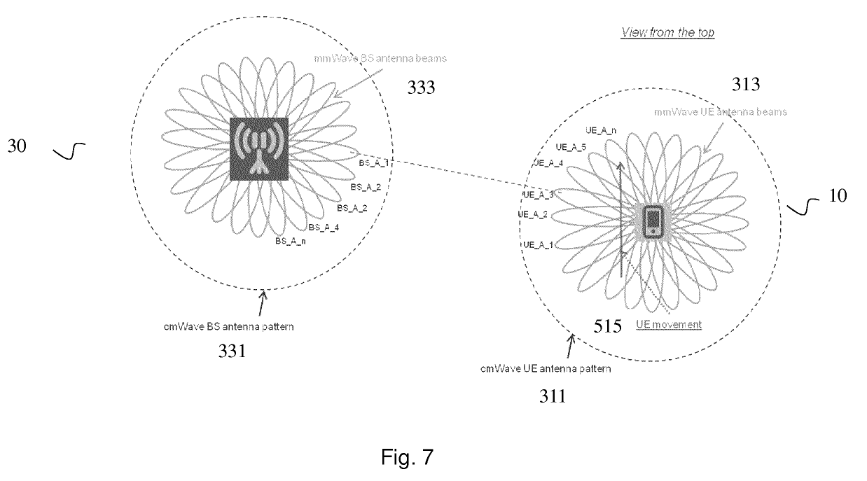

FIG. 7 shows an example beamforming control for movement of the user equipment relative to the access point;

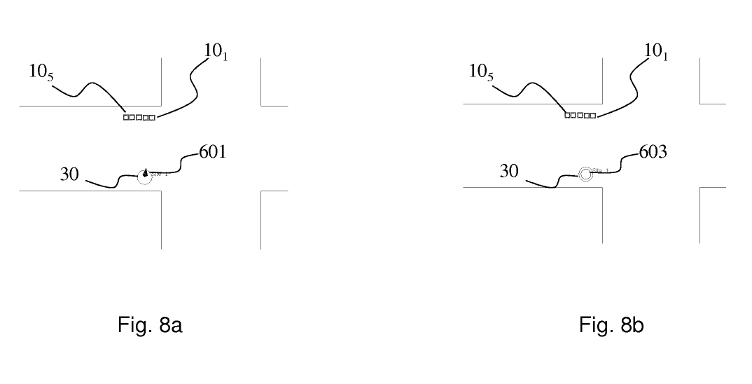

FIGS. 8a and 8b show example simulated beamforming control for movement of the user equipment relative to the access point;

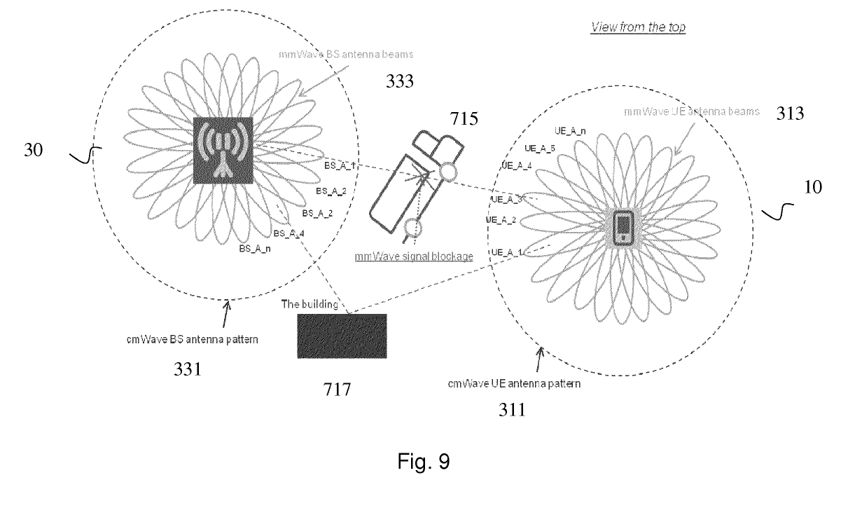

FIG. 9 shows an example beamforming control for a blocked transmission path between the user equipment and access point; and

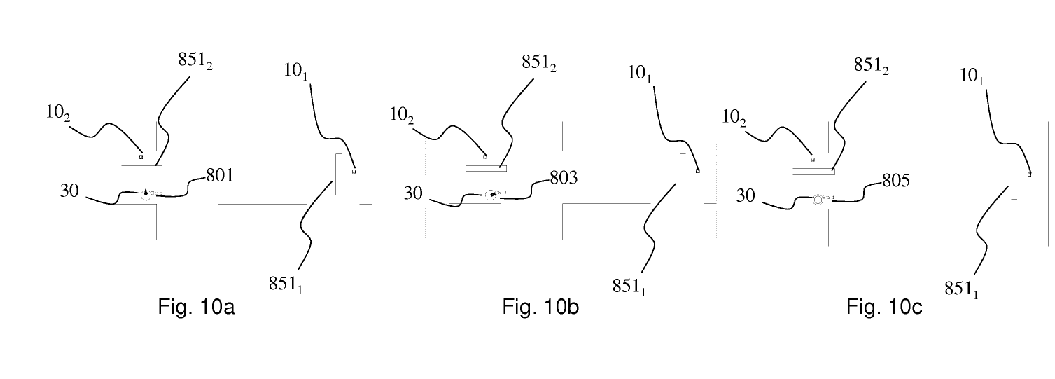

FIGS. 10a, 10b and 10c show example simulated beamforming control for a blocked transmission path between the user equipment and access point.

In the following certain exemplifying embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1 to 2 to assist in understanding the technology underlying the described examples.

A non-limiting example of communication system architectures is the long-term evolution (LTE) of the Universal Mobile Telecommunications System (UMTS) that is being standardized by the 3rd Generation Partnership Project (3GPP). The LTE employs a mobile architecture known as the Evolved Universal Terrestrial Radio Access Network (E-UTRAN). Access point are provided by base stations which in such systems are known as evolved or enhanced Node Bs (eNodeBs; eNBs) and may provide E-UTRAN features such as user plane Radio Link Control/Medium Access Control/Physical layer protocol (RLC/MAC/PHY) and control plane Radio Resource Control (RRC) protocol terminations towards communication devices. Other examples of radio access system include those provided by base stations of systems that are based on technologies such as wireless local area network (WLAN) and/or WiMax (Worldwide Interoperability for Microwave Access).

A communication device 10 or terminal can be provided wireless access via base stations or similar wireless transmitter and/or receiver nodes providing access points of a radio access system.

Each of the access points may provide at least one antenna beam directed in the direction of the communication device 10. The antenna beam can be provided by appropriate elements of antenna arrays of the access points. For example, access links between the access points (AP) and a user equipment (UE) can be provided by active antenna arrays. Such arrays can dynamically form and steer narrow transmission/reception beams and thus serve UEs and track their positions. This is known as UE-specific beamforming. The active antenna arrays can be used both at the AP and at the UE to further enhance the beamforming potential. More than one beam can be provided by each access point and/or antenna array.

Access points and hence communications there through are typically controlled by at least one appropriate controller apparatus so as to enable operation thereof and management of mobile communication devices in communication therewith. FIG. 1 shows an example of a control apparatus for a node, for example to be integrated with, coupled to and/or otherwise for controlling any of the access points. The control apparatus can be arranged to provide control on communications via antenna beams by the access points and on operations such as handovers between the access points. For this purpose the control apparatus comprises at least one memory 31, at least one data processing unit 32, 33 and an input/output interface 34. Via the interface the control apparatus can be coupled to relevant other components of the access point. The control apparatus can be configured to execute an appropriate software code to provide the control functions. It shall be appreciated that similar components can be provided in a control apparatus provided elsewhere in the network system, for example in a core network entity. The control apparatus can be interconnected with other control entities. The control apparatus and functions may be distributed between several control units. In some embodiments, each base station can comprise a control apparatus. In alternative embodiments, two or more base stations may share a control apparatus.

Access points and associated controllers may communicate with each other via fixed line connection and/or air interface. The logical connection between the base station nodes can be provided for example by an X2 interface. This interface can be used for example for coordination of operation of the stations.

The communication device or user equipment (UE) 10 may comprise any suitable device capable of at least receiving wireless communication of data. For example, the device can be handheld data processing device equipped with radio receiver, data processing and user interface apparatus. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. Further examples include wearable wireless devices such as those integrated with watches or smart watches, eyewear, helmets, hats, clothing, ear pieces with wireless connectivity, jewellery and so on, universal serial bus (USB) sticks with wireless capabilities, modem data cards, machine type devices or any combinations of these or the like.

FIG. 2 shows a schematic, partially sectioned view of a possible communication device. More particularly, a handheld or otherwise mobile communication device (or user equipment UE) 10 is shown. A mobile communication device is provided with wireless communication capabilities and appropriate electronic control apparatus for enabling operation thereof. Thus the mobile device 10 is shown being provided with at least one data processing entity 26, for example a central processing unit and/or a core processor, at least one memory 28 and other possible components such as additional processors 25 and memories 29 for use in software and hardware aided execution of tasks it is designed to perform. The data processing, storage and other relevant control apparatus can be provided on an appropriate circuit board 27 and/or in chipsets. Data processing and memory functions provided by the control apparatus of the mobile device are configured to cause control and signalling operations in accordance with certain embodiments of the present invention as described later in this description. A user may control the operation of the mobile device by means of a suitable user interface such as touch sensitive display screen or pad 24 and/or a key pad, one of more actuator buttons 22, voice commands, combinations of these or the like. A speaker and a microphone are also typically provided. Furthermore, a mobile communication device may comprise appropriate connectors (either wired or wireless) to other devices and/or for connecting external accessories, for example hands-free equipment, thereto.

The mobile device may communicate wirelessly via appropriate apparatus for receiving and transmitting signals. FIG. 2 shows schematically a radio block 23 connected to the control apparatus of the device. The radio block can comprise a radio part and associated antenna arrangement. The antenna arrangement may be arranged internally or externally to the mobile device. The antenna arrangement may comprise elements capable of beamforming operations.

The following example is given in relation to communications between mmWave access points (AP) and user equipment (UE) (communications devices). A characteristic of radio wave propagation in mmWave is high level of attenuation by obstacles and large diffraction loss. This can mean that obstacles such trees, cars, humans and other obstacles that may be present in a typical use environment can cause considerable attenuation of radio waves. The attenuation can be many times greater than 20 dB. This effect is even more severe due the fact that with large antenna arrays the antenna beamwidth can be relatively narrow. This can cause a complete radio link failure between an AP and a UE. In case of signal blockage by an obstacle the beamforming procedure needs to find a different beam pair for communications between an AP and a UE. For example, the antenna beams can be redirected so that signal transmission is maintained by reflection of radio waves when line of sight (LOS) path is blocked. Otherwise handover procedure to a neighbour AP shall be performed. Similarly signal loss and antennae beamwidth control is maintained for relative motion or rotation between the AP and the UE.

The listed above cases which may trigger RF beamforming (beam-alignment) algorithm to find new beams alignment may be detected by the device or the system. Furthermore as discussed herein in some embodiments the AP/UE may be configured to detect the particular case (rotation/motion/block) in order to allow the implementation or employment of special RF beamforming (beam-alignment) procedures appropriate to the determined situation. These specific or special RF beamforming procedures may decrease the search time for new beam alignments.

In the following embodiments the radio block implemented in at least one of the UE or AP is such that the mmWave system implemented is configured to cooperate with cmWave systems. In such a manner the cmWave system may provide coverage where the mmWave system coverage is much lower and susceptible to signal drops due to obstacles and different blockages like cars, trees and even humans.

The mmWave and cmWave cooperation or systems integration may in some embodiments be implemented in a manner such as:

1) Dual Connectivity

In this example the cmWave system is used as Control Plane and mmWave signal is used in Data Plane only. The mmWave system is used for boosting the throughput when UE is in the mmWave BS coverage. The cmWave system is used for signalling and to enhance some mmWave procedures like cell search and beam-alignment.

2) Limited Cooperation Between Systems

In this example both systems cmWave and mmWave have Control and Data planes. However integration between both systems exists such that for example some signalling information typically sent on cmWave systems can be targeted for transmission on the mmWave system or some signalling information from the mmWave systems are transferred to the cmWave system.

The following examples for beamforming control may be employed for both types of integrations.

The concept presented hereafter is one wherein a ‘case’ determination or a detection of the UE rotation, UE movement and beam blockages is performed by analysing wide beamwidth cmWave signal characteristics which may be transferred or used as an input to a mmWave beam-alignment algorithm (as well as an analysis of the narrow beamwidth mmWave signal characteristics). The beam-alignment algorithm or beamforming control may trigger appropriate beam search procedures. The algorithm may then implement a beam search procedure appropriate to the determined situation which decreases beam alignment time and improve overall key performance indicators such as throughput, cell search time etc.

With respect to FIG. 3 an example beamwidth controller or beam-alignment system or apparatus is shown according to some embodiments. In some embodiments the beamwidth controller comprises a RF signal input 101. The RF signal input 101 can be configured to receive the millimetre waveform (mmWave) and centimetre wave (cmWave) system input signals from the antennas or beams. The mmWave and cmWave input signals may be passed to the mmWave characteristic determiner 103 and the cmWave characteristic determiner 105 respectively.

In some embodiments of the RF signal input 101 may be configured to receive the raw signals from the analogue to digital converter from the antenna and process the input signals to generate the cmWave and mmWave input signals. Thus for example in some embodiments the RF signal input 101 is configured to generate suitable mmWave input signals for a range of narrow width beams.

In some embodiments the beamwidth controller or beam-alignment system further comprises a first beamwidth signal characteristic determiner or mmWave characteristic determiner 103. The mmWave characteristic determiner 103 may be configured to receive the first beamwidth (or mmWave) input signals from the RF signal input 101 and determine or generate a performance characteristic based on the narrow beam width mmWave input signals. For example in some embodiments the performance characteristic is the signal-to-noise ratio (SNR) or other suitable performance characteristic. The performance characteristic such as the SNR can be output to the signal based event determiner 107.

In some embodiments the beamwidth controller or beam-alignment system further comprises a second beamwidth signal characteristic determiner or cmWave characteristic determiner 105. The cmWave characteristic determiner 105 may be configured to receive the second beamwidth (or cmWave) input signals from the RF signal input 101 and determine or generate a performance characteristic based on the wide beam width cmWave input signals. For example in some embodiments the performance characteristic is also the signal-to-noise ratio (SNR) or other suitable performance characteristic. The performance characteristic such as the SNR can be output to the signal based event determiner 107.

Furthermore in some embodiments the beamwidth controller or beam-alignment system further comprises an event determiner 107 (or signal based event determiner 107). The event determiner 107 can be configured to receive the performance characteristics from the mmWave and cmWave characteristic determiners and determine whether there is a signal based event which requires the need to search for a new beam or control the current beam. Examples of such events are device rotation, device motion, and device transmission path blocked. The output of the event determiner 107 may for example be an indicator configured to indicate to a beam alignment controller 109 the type of event detected.

The beamwidth controller or beam-alignment system furthermore may comprise a beam alignment controller 109. The beam alignment controller 109 may be configured to control or select beams for the mmWave system based on the input received from the event determiner 107. Furthermore in some embodiments the beam alignment controller 109 may receive the mmWave signal inputs as further inputs for controlling or selecting suitable beams based on the determined signal based event. Examples of the events and beam controls are provided in sections hereafter.

With respect to FIG. 4 the operation of the beamwidth controller shown in FIG. 3 is shown in further detail.

The beamwidth controller and specifically the RF signal input 101 may be configured to receive RF signals from the mmWave and the cmWave systems such as the antennas or analogue to digital converters or mixers.

The operation of receiving the RF signals is shown in FIG. 4 by step 201.

The beamwidth controller and specifically the mmWave characteristic determiner 103 and cmWave characteristic determiner 105 may be then be configured to determine performance characteristics (for example the signal to noise ratio) for the mmWave signals and the cmWave signals.

The operation of determining the performance characteristics is shown in FIG. 4 by step 203.

The beamwidth controller and in some embodiments the event determiner 107 may process the determined characteristics to determine whether a signal based event or trigger event has been reached.

The operation of determining whether a signal based event has occurred in order to trigger a specific beam antenna search based on the determined characteristics is shown in FIG. 4 by step 205.

The beamwidth controller and in some embodiments the beam alignment controller 109 may then be configured to control the mmWave beam based on the determined event (and the mmWave input signals and/or signal characteristics). For example by performing a specific control algorithm based on the determined case.

The operation of controlling the mmWave beam system based on the determined event is shown in FIG. 4 by step 207.

With respect to FIG. 5 an example rotation event is shown. FIG. 5 shows the AP 30 which has a wide beamwidth cmWave BS antenna pattern 331. The wide beamwidth cmWave BS antenna pattern 331 is an omnidirectional pattern shown by the dashed circle around the AP 30. The AP 30 furthermore is shown with a plurality of mmWave BS antenna beam patterns 333. The mmWave BS antenna beam patterns 333 are shown as narrow width directional patterns of which BS_A_1, BS_A_2, BS_A_3, BS_A_4, and BS_A_n are explicitly labelled in FIG. 5.

FIG. 5 also shows the UE 10 which has a wide width cmWave UE antenna pattern 311. The wide beamwidth cmWave BS antenna pattern 311 is an omnidirectional pattern shown by the dashed circle around the UE 10. The UE 10 furthermore is shown with a plurality of mmWave UE antenna beam patterns 313. The mmWave BS antenna beam patterns 313 are shown as narrow beamwidth directional patterns of which UE_A_1, UE_A_2, UE_A_3, UE_A_4, UE_A_5 and UE_A_n are explicitly labelled in FIG. 5.

The device rotation 315 (signal based) event may be expressed as when the beams directions are the same but device rotation causes the mmWave ‘active’ beam or the mmWave beam that is currently in use to come out of alignment with the AP 30. In this event or case the mmWave signal level drops but the cmWave signal level is stable because cmWave is using the omnidirectional antenna and device rotation does not cause significant signal drop (although in practice eventually some signal fluctuation can be observed).

Thus the event determiner 107 determines that the device is rotating by determining that the cmWave signal level is substantially stable (or that the change is less than a determined rotation event threshold) but the mmWave signal level is dropping. In other words the event determiner 107 may be configured to determine a rotation event when at least one performance characteristic associated with the received first beamwidth signal shows a change in signal greater than a first beamwidth signal rotation event threshold and the at least one performance characteristic associated with the received second beamwidth signal changes by less than a second beamwidth signal rotation event threshold.

Furthermore the event determiner 107 may control the beam alignment controller such that the mmWave RF beamforming (beam-alignment) should not start new beam direction finding but keeps the current beams direction in both AP and UE by changing only the index of antenna beam in the UE to maintain the same beams direction. In other words the beamwidth controller is configured to control a rotating device antenna beam to search for a different antenna beam, starting with antenna beams neighbouring a currently used antenna beam direction. In some embodiments the beamwidth controller is configured to control a device connected to the rotating device to maintain using a currently used antenna beam.

For example in the example shown in FIG. 5 the mmWave beams BS_A_1 and UE_A_3 are aligned. When the UE 10 or communication device is starting to rotate 315 as depicted in the Figure the UE_A_3 beam is also rotating and will be not aligned with BS_A_1 beam. The mmWave beam-alignment algorithms in the AP 30 and UE 10 will be triggered to search for new beam alignment. However as we can see in case of UE rotation the beam direction is not changing so the UE beam direction and AP beam direction should stay the same and only the beam index of UE should be change when UE is rotating.

In other words the detection that the UE is rotating may be performed by analysing the pilot of the cmWave signal which is sent and received by an omnidirectional (or wide antenna) pattern. The cmWave signal is stable in the event of the UE rotating so this information should be sent to mmWave part of the devices and the AP should keep the same index of antenna beam and UE beam-alignment algorithm should change the UE beam index accordingly to keep the same direction of the beam.

The effect of the device rotation was simulated based on the FIGS. 6a, 6b and 6c. The device rotation simulation was performed using a ray-tracing tool (WinProp ver.13) to show the effects of the device rotation for the mmWave signal using narrow beamwidth antenna and cmWave signal using omnidirectional antenna. The main simulation assumptions were
cmWave frequency: 2 GHz
mmWave frequency: 73.5 GHz
BTS cmWave antenna: omnidirectional, 0 dBi gain, 5 m height
BTS mmWave antenna: antenna array 4×4, half power beamwidth 25 deg, 12 dBi gain, 5 m height
UE antenna: omnidirectional. 0 dBi gain, 1.5 m height
base station transmit power: 20 dBm
propagation model: Standard Ray Tracing with Fresnel/UTD(GTD) model for interactions
materials types: building—concrete, ground—asphalt

In the simulation of the mmWave the antenna array was used only in Base Station (TX) because this is not possible to use directional antenna in RX in WinProp. Therefore the receiving device simulates an omnidirectional antenna. In other words signal loss in the mmWave system due to device rotation is much more significant because of beam misalignment between UE and AP may be much more severe.

The layout for simulation of device rotation effect for mmWave signal is presented in FIGS. 6a, 6b and 6c. As the simulation software does not allow the use of directional antenna in the UE the effect of rotation was simulated within the AP antenna beam alignment with the UE. The simulated misalignment was about 7 degrees.

Thus for example FIG. 6a shows the UE 10 and the AP 30 in plan view with an aligned mmWave system, in other words the AP mmWave antenna beam 401 is aligned with UE 10. Whereas FIG. 6b shows the UE 10 and the AP 30 in plan view with an rotated or misaligned mmWave system, in other words the AP mmWave antenna beam 403 is rotated (by approximately 7 degrees) with respect to the aligned antenna beam 401 shown in FIG. 6a. Furthermore FIG. 6c shows the cmWave signal beam 405 with respect to the UE 10 and AP 30.

The simulated results of the received (RX) power of the cmWave and mmWave signal at the UE are listed below.

| | cmWave UE RX power | mmWave UE RX power |
|---|---|---|
| Type of action | [dBm] | [dBm] |
| No device rotation | −51.5 | −59.6 |
| (beam is aligned) | | |
| Device rotation | −51.5 | −62.1 |
| (beam is not aligned) | | |

From these simulated results it is possible to see that device rotation causes the signal drop in the mmWave signal but at the same time the signal strength of cmWave is the same (in practice some small fluctuation can be visible due to non-perfect omnidirectional cmWave antenna).

With respect to FIG. 7 an example motion event is shown. FIG. 7 shows the AP 30 which has a wide beamwidth cmWave BS antenna pattern 331. The wide beamwidth cmWave BS antenna pattern 331 is an omnidirectional pattern shown by the dashed circle around the AP 30. The AP 30 furthermore is shown with a plurality of mmWave BS antenna beam patterns 333. The mmWave BS antenna beam patterns 333 are shown as narrow beamwidth directional patterns of which BS_A_1, BS_A_2, BS_A_3, BS_A_4, and BS_A_n are explicitly labelled in FIG. 7.

FIG. 7 also shows the UE 10 which has a wide beamwidth cmWave UE antenna pattern 311. The wide beamwidth cmWave BS antenna pattern 311 is an omnidirectional pattern shown by the dashed circle around the UE 10. The UE 10 furthermore is shown with a plurality of mmWave UE antenna beam patterns 313. The mmWave BS antenna beam patterns 313 are shown as narrow beamwidth directional patterns of which UE_A_1, UE_A_2, UE_A_3, UE_A_4, UE_A_5 and UE_A_n are explicitly labelled in FIG. 7.

The device motion 515 (signal based) event may be expressed in this case as when device changes its position and the current beam(s) alignment is not optimal. When such an event is determined the mmWave beam alignment algorithms in the AP 30 and UE 10 may be triggered to search for new beam(s) alignments. For example in some embodiments the beam alignment algorithms (the beam alignment controller 109) may be configured to select or search the neighbouring beams to the current beam in order to obtain an acceptable level of performance. Therefore when the event determiner 107 determines a UE movement then the mmWave beam-alignment algorithm can start with a scanning of the neighbouring beams in both devices. The event determiner 107 may determine a device movement event by analysing the cmWave signal strength which in UE movement will start to fluctuate because the propagations paths are changing. These changes may be less than a determined motion event threshold. In some embodiments these changes may be more than a determined rotation event threshold but less than a blocked antenna beam event threshold.

In other words the event determiner 107 in some embodiments is configured to determine a device motion event when the at least one performance characteristic associated with the received first beamwidth signal (the mmWave signal) shows a change in signal greater than a first beamwidth signal motion event threshold and the at least one performance characteristic associated with the received second beamwidth signal (the cmWave signal) shows a change in signal less than a second beamwidth signal motion event threshold.

Thus for example in FIG. 7 the initial beams are BS_A_1 and UE_A_3. In case of device movement 515 as indicated in the FIG. 7 the initial beams will go out of alignment. However UE movement may be determined by observing changes in cmWave pilot signal. When UE movement is detected the mmWave algorithms in the AP and UE will start beam searching starting from neighbouring beams, for example in UE: UE_A_1, UE_A_2, UE_A_4, UE_A_5. In other words the beamwidth controller 109 may be configured to control a moving device antenna beam to search for a different antenna beam, wherein the search starts with antenna beams neighbouring a currently used antenna beam direction. In some embodiments the beamwidth controller 109 may be configured to further control a device connected to the moving device antenna beam to search for a different antenna beam, wherein the search starts with antenna beams neighbouring a currently used antenna beam direction.

The simulation of the device movement event for mmWave signals is presented in FIG. 8a and for cmWave signal in FIG. 8b. The device movement was simulated as 5 UE positions spaced about 1.5 m from each other of which the first position 10₁ and the fifth position 10₅ are explicitly labelled. FIG. 8a thus shows the AP 30 and the mmWave beam orientation 601 and the UE positions 10₁, . . . , 10₅. FIG. 8b shows the AP 30 and the cmWave beam onmi-orientation 603 and the UE positions 10₁, . . . , 10₅.

The simulated RX power of cmWave and mmWave signal in case of device movement is shown here.

| | cmWave UE RX power | mmWave UE RX power |
|---|---|---|
| Type of action | [dBm] | [dBm] |
| Device position | −38.6 | −58.8 |
| 1 | | |
| Device position | −41.7 | −60.6 |
| 2 | | |
| Device position | −40.6 | −68.0 |
| 3 | | |
| Device position | −38.4 | −72.0 |
| 4 | | |
| Device position | −41.8 | −84.1 |
| 5 | | |

From this simulation it can be seen that the mmWave signal is decreasing quite significantly when UE is moving because antenna beam is oriented in the same direction. The cmWave signal also shows a few dB's fluctuation in received power due to different propagation effects like reflection from different objects, different angle of diffraction etc.

With respect to FIG. 9 an example blocked beam or beam blockage event is shown. FIG. 9 shows the AP 30 which has a wide beamwidth cmWave BS antenna pattern 331. The wide beamwidth cmWave BS antenna pattern 331 is an omnidirectional pattern shown by the dashed circle around the AP 30. The AP 30 furthermore is shown with a plurality of mmWave BS antenna beam patterns 333. The mmWave BS antenna beam patterns 333 are shown as narrow beamwidth directional patterns of which BS_A_1, BS_A_2, BS_A_3, BS_A_4, and BS_A_n are explicitly labelled in FIG. 7.

FIG. 9 also shows the UE 10 which has a wide beamwidth cmWave UE antenna pattern 311. The wide beamwidth cmWave BS antenna pattern 311 is an omnidirectional pattern shown by the dashed circle around the UE 10. The UE 10 furthermore is shown with a plurality of mmWave UE antenna beam patterns 313. The mmWave BS antenna beam patterns 313 are shown as narrow beamwidth directional patterns of which UE_A_1, UE_A_2, UE_A_3, UE_A_4, UE_A_5 and UE_A_n are explicitly labelled in FIG. 9. Furthermore FIG. 9 shows a mmWave signal blockage (shown as a truck) 715, and a mmWave indirect path reflective surface (shown as a building) 717.

The signal blockage 715 (signal based) event may be expressed in this case as when mmWave beams are blocked by some obstruction. In this event or case the mmWave signal is dropped and the event determiner 107 may trigger a mmWave beam-alignment algorithm. In such embodiments therefore the event determiner (107) may be configured to determine a signal blockage event when the at least one performance characteristic associated with the received first beamwidth signal (the mmWave signal) shows a change in signal greater than a first beamwidth signal blockage event threshold and the at least one performance characteristic associated with the received second beamwidth signal (the cmWave signal) shows a change in signal greater than a second beamwidth signal blockage event threshold. Furthermore in such embodiments the beamwidth controller 109 may be configured to control a blocked device antenna beam to search for a different antenna beam. In these embodiments the beamwidth controller 109 may furthermore be configured to control a device connected to the blocked device antenna beam to search for a different antenna beam.

In this event when the line of sight (LOS) is obstructed the communication can be maintained only by mmWave propagation by reflections. Furthermore the mmWave transmission losses require a very small number of reflections in order to maintain a short path length and so in most cases one reflection of wave maintains a reasonable signal strength. Thus having determined a signal blockage the beam alignment controller implementing a mmWave algorithm should search new beams for alignment using a full range of possible beams (as it is not possible to predict the best new path from AP to UE).

Furthermore the event determiner 107 may be configured to determine the signal or beam blockage by analysing the cmWave signal. In this case the cmWave signal will also drop to some level due to wide characteristics of AP and UE antennas (although typically the communication is still possible between the two devices). Furthermore the cmWave signal drop is typically greater than the device movement event signal drop. In some embodiments therefore the event determiner 107 is configured with a threshold drop level which enables the determination between the moving device and the blocked antenna beam or blocked beam signal events.

In the example in FIG. 9 the initial mmWave communication between beams BS_A_1 and UE_A_3 is obstructed by a truck. In the cmWave signal this blockage is characterized by significant reduction in signal level because the line of sight is obstructed. Having determined that both the mmWave communication signal has dropped significantly (in other words the mmWave signal has dropped by more than a determined or threshold value) and the cmWave communication signal has also dropped significantly (in other words the cmWave signal has dropped by more than a determined or threshold value) then the indicator passed to the beam alignment controller 109 may trigger a mmWave beam-alignment algorithms in the AP and UE which causes a full search for new beam alignment.

The effect of the beam blockage was simulated based on the FIGS. 10a, 10b and 10c. The plan of the simulation of beam blockage for mmWave signal is presented in FIGS. 10a and 10b and for the cmWave signal in FIG. 10c. The simulation was performed for two UEs positions and with and without blockages (the blockage object consists of metal with size similar to truck). Thus for example FIG. 10a shows a first UE 10₁ and a second UE 10₂ and the AP 30 in plan view. Furthermore there is shown in FIG. 10a a first blocking element (truck) 851₁ located between the first UE 10₁ and the AP 30, and a second blocking element 851₂ located between the second UE 10₂ and the AP 30. The example shown in FIG. 10a shows an aligned mmWave system with the AP mmWave antenna beam 801 aligned with the second UE 10₂. Whereas FIG. 10b shows a first UE 10₁ and a second UE 10₂ and the AP 30, a first blocking element (truck) 851₁ located between the first UE 10₁ and the AP 30, and a second blocking element 851₂ located between the second UE 10₂ and the AP 30. The example shown in FIG. 10b shows an aligned mmWave system with the AP mmWave antenna beam 803 aligned with the first UE 10₁. FIG. 10c shows a first UE 10₁ and a second UE 10₂ and the AP 30. Furthermore there is shown in FIG. 10a a first blocking element (truck) 851₁ located between the first UE 10₁ and the AP 30, and a second blocking element 851₂ located between the second UE 10₂ and the AP 30. The example shown in FIG. 10c shows the cmWave signal beam 805 with respect to the first and second UEs and the AP 30.

The simulation results with respect to the second UE 10₂ are presented hereafter

| | cmWave UE1 RX power | mmWave UE1 RX power |
|---|---|---|
| Type of action | [dBm] | [dBm] |
| No blockage | −38.4 | −59.6 |
| Blockage | −55.3 | −86.2 |

The simulation results with respect to the first UE 10₁ are presented hereinafter

| | cmWave UE2 RX power | mmWave UE2 RX power |
|---|---|---|
| Type of action | [dBm] | [dBm] |
| No blockage | −51.5 | −69.9 |
| Blockage | −85.7 | −87.4 |

In both the UEs there is a significant signal drop for both cmWave and mmWave signals when the blockage is located on the line of sight between the UE and AP.

As is shown by the simulations in order to determine the events such as device rotation, device motion and beam blockage then both the cmWave and the mmWave signals are analysed as analysis of only the mmWave signal strength is not good enough because in all cases the mmWave signal strength is decreased significantly.

The idea requires standardization for Dual Connectivity architecture and also for limited cooperation between cmWave and mmWave systems. The standardization is required for Control layer of cmWave system which should exchange information to mmWave control layer about detection of device rotation, movement or beam blockage.

The idea is targeted for BTS and UE side. In BTS the idea could be implemented when mmWave and cmWave part of base station have the same location. In the UE side the both part of systems are implemented so this is valid for all types of planned types of 5G integration of cmWave and mmWave technologies.

The types of beam-alignment algorithms are not discussed herein as the algorithms for controlling the beam alignments are mainly proprietary solutions and known methods.

In some embodiments the cmWave channel and its pilot bits may be employed as the cmWave signal input being analysed.

Although the performance characteristic shown and described herein is one of the signal strength or signal to noise value it is understood that there may be other characteristics such as for example:
RTT—Round Trip Time: to recognize if the LOS is blocked
AoA—angle of arrival: to recognize all mentioned types of events

The required data processing apparatus and functions of a network elements such as base station apparatus and other access points and controller elements, a communication device, a core network element and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method for wireless communications, comprising:
determining at least one performance characteristic associated with a received first beamwidth signal;
determining at least one performance characteristic associated with a received second beamwidth signal;
determining a signal related event based on the at least one performance characteristic associated with the received first beamwidth signal and the at least one performance characteristic associated with the received second beamwidth signal; and
controlling an antenna beam for transmitting and receiving the second beamwidth signal based on the signal related event.

2. The method according to claim 1, wherein determining at least one performance characteristic associated with the received first beamwidth signal comprises determining at least one of:
a received signal strength level;
a received signal to noise level;
a round trip time; and
an angle of arrival.

3. The method according to claim 1, wherein determining at least one performance characteristic associated with the received second beamwidth signal comprises determining at least one of:
a received signal strength level;
a received signal to noise level;
a round trip time; and
an angle of arrival.

4. The method according to claim 1, wherein determining a signal related event based on the at least one performance characteristic associated with the received first beamwidth signal and the at least one performance characteristic associated with the received second beamwidth signal comprises determining a device rotation event when the at least one performance characteristic associated with the received first beamwidth signal shows a change in signal greater than a first beamwidth signal rotation event threshold and the at least one performance characteristic associated with the received second beamwidth signal changes by less than a second beamwidth signal rotation event threshold.

5. The method according to claim 1, wherein controlling an antenna beam for transmitting and receiving the second beamwidth signal based on the signal related event comprises:
controlling a device to search for a different antenna beam, wherein the search starts with antenna beams neighbouring a currently used antenna beam direction; and
controlling a further device, connected to the device, to maintain using a currently used antenna beam.

6. The method according to claim 1, wherein determining a signal related event based on the at least one performance characteristic associated with the received first beamwidth signal and the at least one performance characteristic associated with the received second beamwidth signal comprises determining a device motion event when the at least one performance characteristic associated with the received first beamwidth signal shows a change in signal greater than a first beamwidth signal motion event threshold and the at least one performance characteristic associated with the received second beamwidth signal shows a change in signal less than a second beamwidth signal motion event threshold.

7. The method according to claim 1, wherein controlling an antenna beam for transmitting and receiving the second beamwidth signal based on the signal related event comprises:
controlling a device to search for a different antenna beam, wherein the search starts with antenna beams neighbouring a currently used antenna beam direction; and
controlling a further device, connected to the device, antenna beam to search for a different antenna beam direction, wherein the search starts with antenna beams neighbouring a currently used antenna beam.

8. The method according to claim 1, wherein determining a signal related event based on the at least one performance characteristic associated with the received first beamwidth signal and the at least one performance characteristic associated with the received second beamwidth signal comprises determining a signal blockage event when the at least one performance characteristic associated with the received first beamwidth signal shows a change in signal greater than a first beamwidth signal blockage event threshold and the at least one performance characteristic associated with the received second beamwidth signal shows a change in signal greater than a second beamwidth signal blockage event threshold.

9. The method according to claim 1, wherein controlling an antenna beam for transmitting and receiving the second beamwidth signal based on the signal related event comprises:
controlling a device to search for a different antenna beam; and
controlling a further device, connected to the device, to search for a different antenna beam.

10. An apparatus for wireless communications, the apparatus comprising at least one processor, and at least one memory including computer program code, wherein the at least one memory and the computer program code are configured, with the at least one processor, to cause:
determining at least one performance characteristic associated with the received first beamwidth signal;
determining at least one performance characteristic associated with the received second beamwidth signal;
determining a signal related event based on the at least one performance characteristic associated with the received first beamwidth signal and the at least one performance characteristic associated with the received second beamwidth signal; and
controlling an antenna beam for transmitting and receiving the second beamwidth signal based on the signal related event.

11. The apparatus as claimed in claim 10, wherein determining a signal related event based on the at least one performance characteristic associated with the received first beamwidth signal and the at least one performance characteristic associated with the received second beamwidth signal causes the apparatus to perform determining a device rotation event when the at least one performance characteristic associated with the received first beamwidth signal shows a change in signal greater than a first beamwidth signal rotation event threshold and the at least one performance characteristic associated with the received second beamwidth signal changes by less than a second beamwidth rotation event threshold.

12. The apparatus as claimed in claim 10, wherein determining a signal related event based on the at least one performance characteristic associated with the received first beamwidth signal and the at least one performance characteristic associated with the received second beamwidth signal causes the apparatus to perform determining a device motion event when the at least one performance characteristic associated with the received first beamwidth signal shows a change in signal greater than a first beamwidth signal motion event threshold and the at least one performance characteristic associated with the received second beamwidth signal shows a change in signal less than a second beamwidth signal motion event threshold.

13. The apparatus as claimed in claim 10, wherein determining a signal related event based on the at least one performance characteristic associated with the received first beamwidth signal and the at least one performance characteristic associated with the received second beamwidth signal causes the apparatus to perform determining a signal blockage event when the at least one performance characteristic associated with the received first beamwidth signal change in signal greater than a first beamwidth signal blockage event threshold and the at least one performance characteristic associated with the received second beamwidth signal shows change in signal greater than a second beamwidth signal blockage event threshold.

14. A device for a communication system comprising the apparatus according to claim 10.

15. A computer program embodied on a non-transitory computer-readable medium comprising code means adapted to perform the method of claim 1 when the program is run on processor apparatus.

16. An apparatus for wireless communications, the apparatus comprising:
a first beamwidth signal characteristic determiner configured to determine at least one performance characteristic associated with a received first beamwidth signal;
a second beamwidth signal characteristic determiner configured to determine at least one performance characteristic associated with a received second beamwidth signal;
an event determiner configured to determine a signal related event based on the at least one performance characteristic associated with the received first beamwidth signal and the at least one performance characteristic associated with the received second beamwidth signal; and
a beamwidth controller configured to control an antenna beam for transmitting and receiving the second beamwidth signal based on the signal related event.

17. The method according to claim 1, wherein the first beamwidth signal is a narrower beamwidth signal than the second beamwidth signal.

18. The apparatus according to claim 10, wherein the first beamwidth signal is a narrower beamwidth signal than the second beamwidth signal.

19. The apparatus according to claim 16, wherein the first beamwidth signal is a narrower beamwidth signal than the second beamwidth signal.
